(19) United States
(12) Patent Application Publication
(10) Pub. No.: US 2008/0126358 A1
(43) Pub. Date: May 29, 2008

(54) DISPOSAL OF HOSTED ASSETS

(75) Inventors: Ben Turner, Chevy Chase, MD (US); John Evans, Ashburn, VA (US); Anthony Renzette, Ashburn, VA (US)

Correspondence Address: GREENBERG TRAURIG, LLP, 1750 TYSONS BOULEVARD, 12TH FLOOR, MCLEAN, VA, 22102, US

(73) Assignee: The MITA Group, Washington, DC (US)

(21) Appl. No.: 11/745,984

(22) Filed: May 8, 2007

Related U.S. Application Data
(60) Provisional application No. 60/746,756, filed on May 8, 2006.

(51) Int. Cl. G06F 17/30

(52) U.S. Cl. 707/10

(57) ABSTRACT

A system and method for efficiently storing, distributing, and disposing of information assets in an information asset distribution system with a plurality of subscribers. The system stores a single copy of individual assets and distributes a means to access the information assets to interested subscribers. The system disposes of assets when predetermined events occur. Such events may include conditions which indicate some or all interested subscribers have accessed the assets or flagged them for deletion, or that a predetermined time period has elapsed.

This application claims priority from U.S. Provisional Patent Application Ser. No. 60/746,756 filed May 08, 2006, which is incorporated herein by reference in its entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the field of online subscriber-based information services, and in particular to systems and methods for storing, distributing and disposing of hosted assets.

### BACKGROUND OF THE INVENTION

The Internet provides a wide array of information content and online communities. Unfortunately, for an individual subscriber, the amount of information can be overwhelming. While there may exist a wide variety of materials that an individual subscriber may have interest in, such materials are often buried in a much larger group of only marginally related materials. In online communities as well, while such communities may offer focused discussion groups on single topics, subscribers may have a difficult time locating other members with a larger array of similar interests.

For the purposes of the present application the term “information service” is intended to refer to any online service including, without limitation, web sites and bulletin boards accessible through the internet, which provide information in digital format to subscribers of such services.

For the purposes of the present application the term “subscriber” is intended to refer to a subscriber of an information service who has registered with the service and has been assigned a subscriber ID by the service.

For the purposes of the present application the term “subscriber based information services” is intended to refer to an information service which requires a subscriber to register as a subscriber before allowing the subscriber full access to the information content of the service.

For the purposes of the present application the term “assets” is intended to refer to any kind of digital information stored or distributed by an information service such as, without limitation, documents, alerts, feed items, articles, messages, and other forms of digital media, as well as links to digital information stored or distributed by other information services.

For the purposes of the present application the term “keyword” is intended to refer to any word that can be used as a reference point for finding other words or information.

For the purposes of the present application the term “key phrase” is intended to refer to any combination of words that can be used as a reference point for finding other words or information.

For the purposes of the present application the term “lexicon” is intended to refer to a set of keywords and key phrases that can be used to describe attributes of assets and subscribers.

For the purposes of the present application the term “fingerprint” is intended to refer to a set of keywords and key phrases that can be used to describe the attributes of a single asset or a single subscriber. Additionally or alternatively, a fingerprint may include additional information. For example, a fingerprint may include key phrase frequency analysis data, source geography data (e.g., the geographic location of the source of an asset), source site data (e.g., the domain or organization that hosts the source of an asset), author data, subscriber feedback data (e.g., explicit subscriber ratings, inferred subscriber ratings, usage frequency, etc.), and date data.

### SUMMARY OF THE INVENTION

A system and method for efficiently storing, distributing, and disposing of information assets in an information asset distribution system with a plurality of subscribers. The system stores a single copy of individual assets and distributes a means to access the information assets to interested subscribers. The system disposes of assets when predetermined events occur. Such events may include conditions which indicate some or all interested subscribers have accessed the assets or flagged them for deletion, or that a predetermined time period has elapsed.

### BRIEF DESCRIPTION OF THE DRAWINGS

FIG. 1 is a high level schematic of an embodiment of the system described in the detailed description.

FIG. 2 is a schematic of an embodiment of the process used to create the lexicon.

FIG. 3 is a schematic of an embodiment of the process used to create asset fingerprints.

FIG. 4 is a schematic of an embodiment of the process used to create subscriber fingerprints.

FIG. 5 illustrates the categories of data that may be used in an embodiment of the process used to create a subscriber fingerprint.

FIG. 6 illustrates the categories of data that may be retrieved in response to a subscriber query by an embodiment of the system.

FIG. 7 illustrates an embodiment of the processes used to create and modify asset and subscriber fingerprints.

FIG. 8 illustrates the categories of data that may be automatically recommended to an individual subscribers by an embodiment of the system.

FIG. 8 illustrates the categories of data that may be automatically recommended to an individual subscribers by an embodiment of the system.

FIG. 9 is a schematic of an embodiment of data clustering that may occur within an embodiment of the system.

FIG. 10 illustrates the categories of data that may be automatically recommended to multiple subscribers by an embodiment of the system.

### DETAILED DESCRIPTION OF THE PREFERRED EMBODIMENT

Reference will now be made in detail to the preferred embodiments of the present invention, examples of which are illustrated in the accompanying drawings.

The present invention is described below with reference to block diagrams and operational illustrations of methods and devices to store and/or access information assets. It is understood that each block of the block diagrams or operational illustrations, and combinations of blocks in the block diagrams or operational illustrations, may be implemented by means of analog or digital hardware and computer program instructions. These computer program instructions may be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

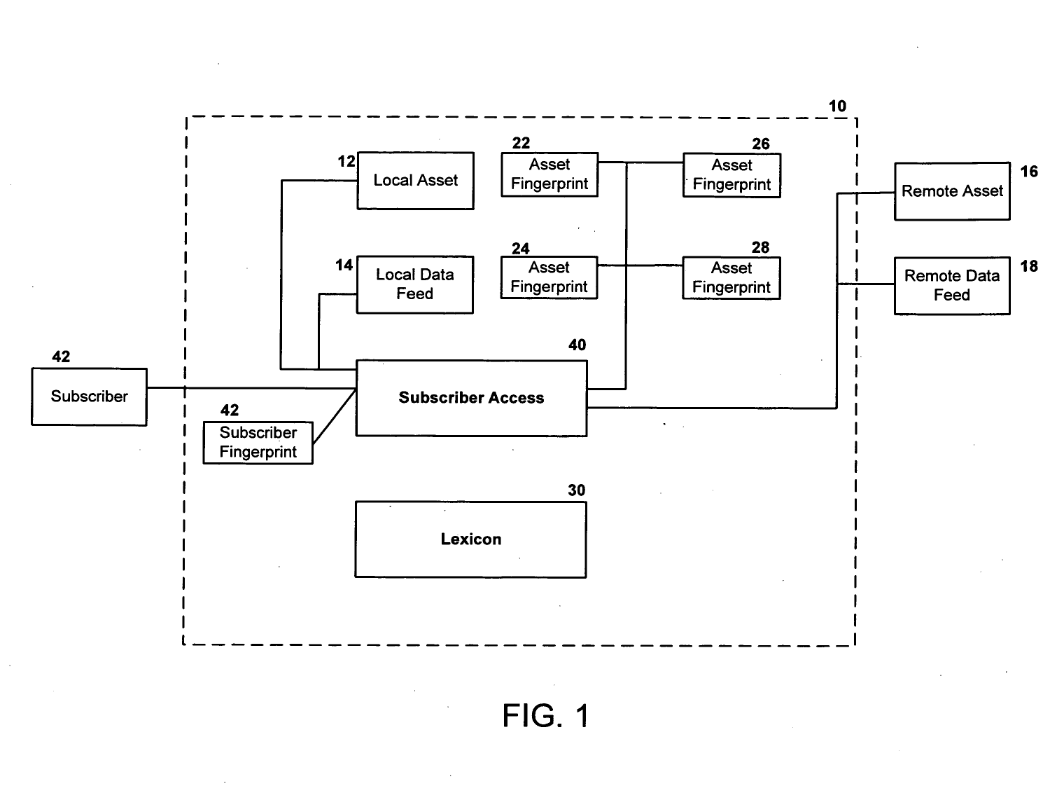

In the embodiment shown in FIG. 1, the system, 10, contains assets, 12, 14, and 16 that are accessible online to subscribers of the service. The assets may be stored locally by the service, 12, may be stored by another information service and linked to by the service, 14, or may be a real-time feed generated by the service, 16, or supplied by another information service, 18. Each asset is associated with data fingerprint, 22, 24, 26, and 28 each data fingerprint being comprised of, in part, keywords and key phrases contained in, or associated with assets, 12, 14, 16 and 18 respectively, and which are also contained in the system's lexicon, 30. The lexicon, 30, contains keywords and key phrases that the system has determined are effective in grouping assets in categories.

Subscribers, 42, are able to log onto the system through a subscriber access process, 40, using credentials that serve to identify the subscriber, for example, a subscriber ID and password. Each subscriber is also associated with a data fingerprint, 44, each data fingerprint being comprised of, in part, keywords and key phrases which describe the subscriber, for example, city of residence, and which are also contained in the system's lexicon, 30. The data fingerprint may also contain keywords and key phrases extracted from activities the subscriber engages in on the service, for example, queries, but only if such keywords and key phrases are on the system's lexicon, 30. The subscriber access component enables subscribers to access assets and other subscribers known to the system using, for example, simple queries or browsing operations. Optionally the subscriber access process, 40, may also use the fingerprints associated with assets and subscribers to filter query results or automatically recommend assets or subscribers that may be of interest to the subscriber, as more fully described below.

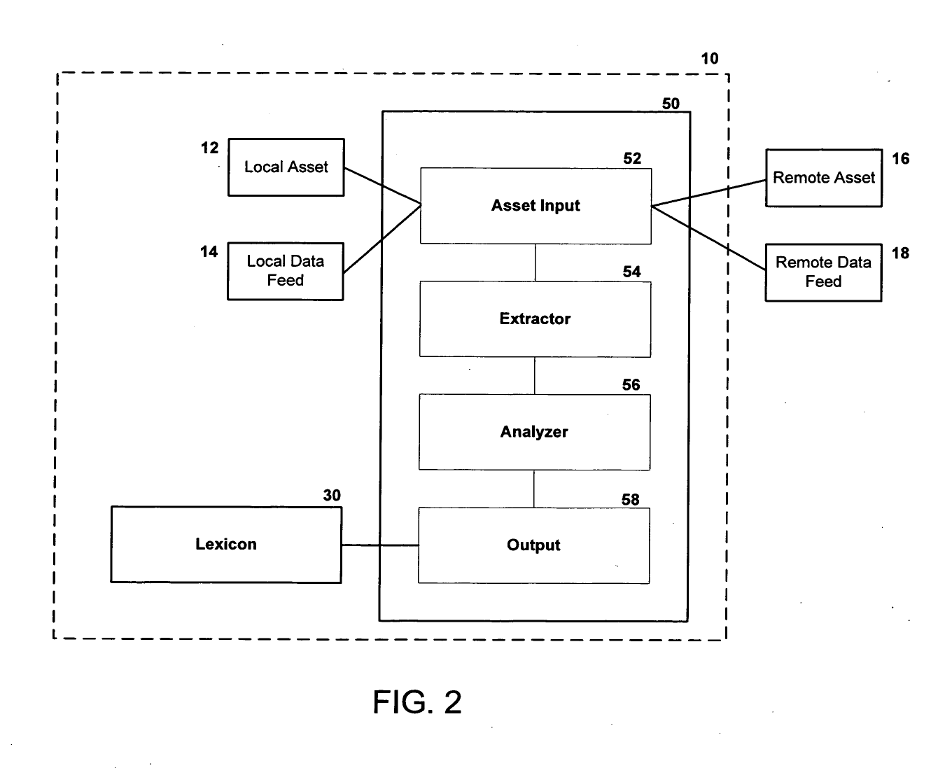

Referring next to FIG. 2, the lexicon is built by a lexicon builder process, 50. The lexicon is derived solely from keywords and key phrases contained in, or associated with, assets. In the first step of the lexicon building process, a group of assets of any type are accessed by an input process within the lexicon builder, 52. Next, words and phrases are extracted from the contents of the assets by an extractor process, 54. Words may be defined as, without limitation, individual tokens composed of one or more characters, bounded by white space. Phrases may be defined as, without limitation, word patterns composed of two or more words.

After all words and phrases have been extracted from the assets, an analyzer process, 56, identifies the frequency with which individual words and phrases. Words and phrases the are found too frequently in assets to be useful to describe assets (e.g., the articles “the” and “a”) and words and phrases that are found too infrequently in assets to be useful to describe assets are discarded. The result is a set of keywords and key phrases, 28, that may be useful for describing the asset. The keywords and key phrases are added to the lexicon by an output process, 58.

As assets are added and removed from the system, it may be appropriate to update the lexicon. In one embodiment, the lexicon builder process could run periodically, inputting all active assets within the system, or, alternatively, inputting all assets of a specific type, or all assets added since the last time the lexicon was updated. In another embodiment, the lexicon builder process could run in real time, and as assets are added, or deleted, the input and extraction process, 52, and 54, runs for individual assets, followed by execution of the analyzer process for the entire set of words and phrases for all assets.

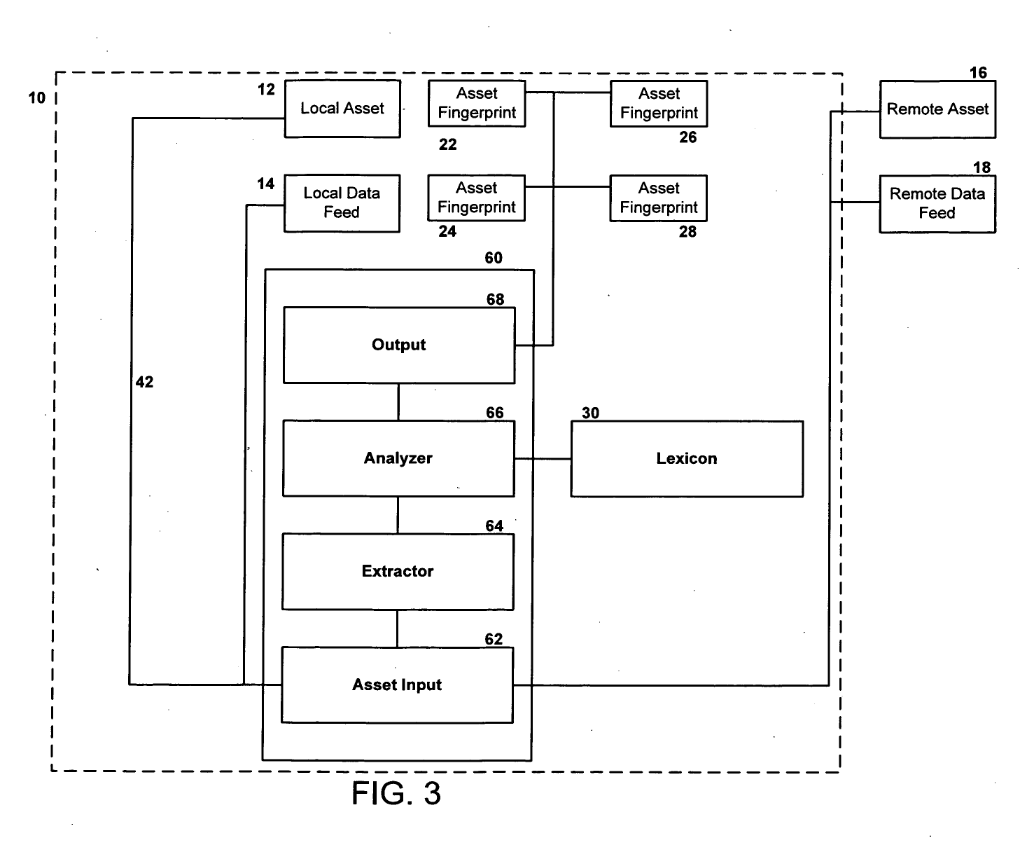

Referring next to FIG. 3, in one embodiment, asset fingerprints are built by an asset fingerprint builder process, 60. In the first step of the process, an asset is accessed by an input process within the asset fingerprint builder process, 62. Next, words and phrases are extracted from the contents of the asset with the assets by an extractor process, 64. The extractor process, 64, discards any words or phrases that are not contained in the systems lexicon, 40. Optionally, an associated information process, 65, gathers information related to the asset, for example source geography data (e.g., the geographic location of the source of an asset), source site data (e.g., the domain or organization that hosts the source of an asset), author data, subscriber feedback data (e.g., explicit subscriber ratings, inferred subscriber ratings, usage frequency, etc.), and date data.

An analyzer process, 66, then inputs the extracted keywords, key phrases, and associated information and uses it to build asset fingerprints. The content of the fingerprint contains information that allows assets to be readily retrieved by simple queries and that also allows assets that pertain to related subjects, for example, a geographic area or a type of food, to be grouped together. In one embodiment, the fingerprint simply contains keywords and key phrases from the lexicon. In another embodiment, the fingerprint may also include key phrase frequency analysis data. In another embodiment, the fingerprint may also contain associated information, such as, for example, geographic origin. The asset fingerprint is then output by an asset fingerprint output process, 68, that associates the fingerprint with the applicable asset.

It may be appropriate, from time to time, to update the asset fingerprint. For example, if the lexicon changes significantly over time, it may be advisable to run the asset fingerprint builder process, 60, for all assets on a periodic basis. Alternatively, the asset fingerprint builder process, 60, could run for an individual asset every time it is accessed.

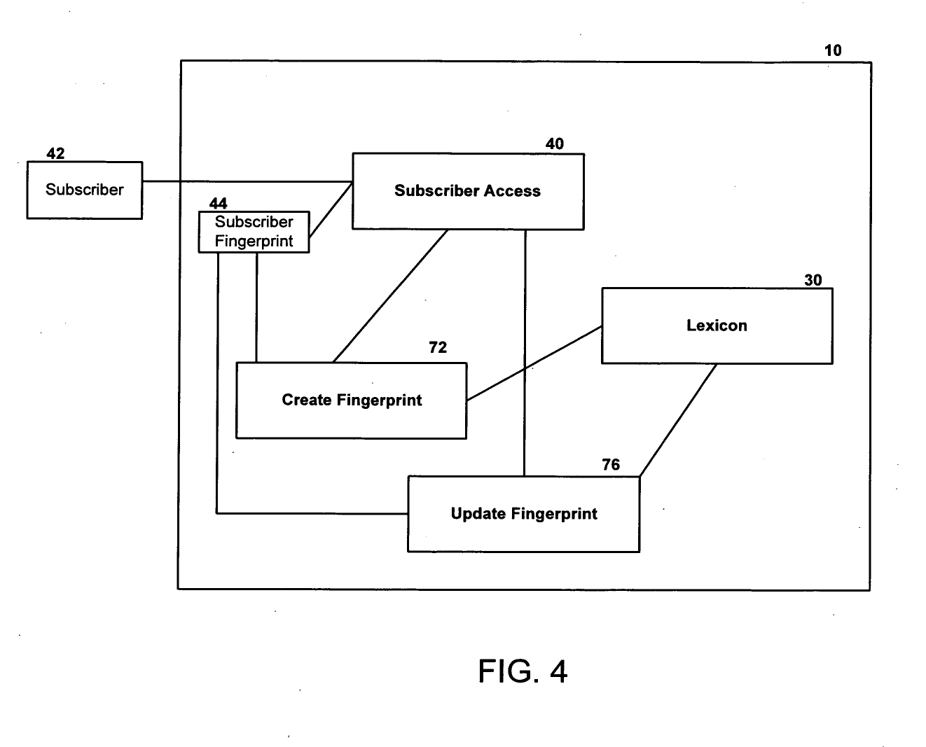

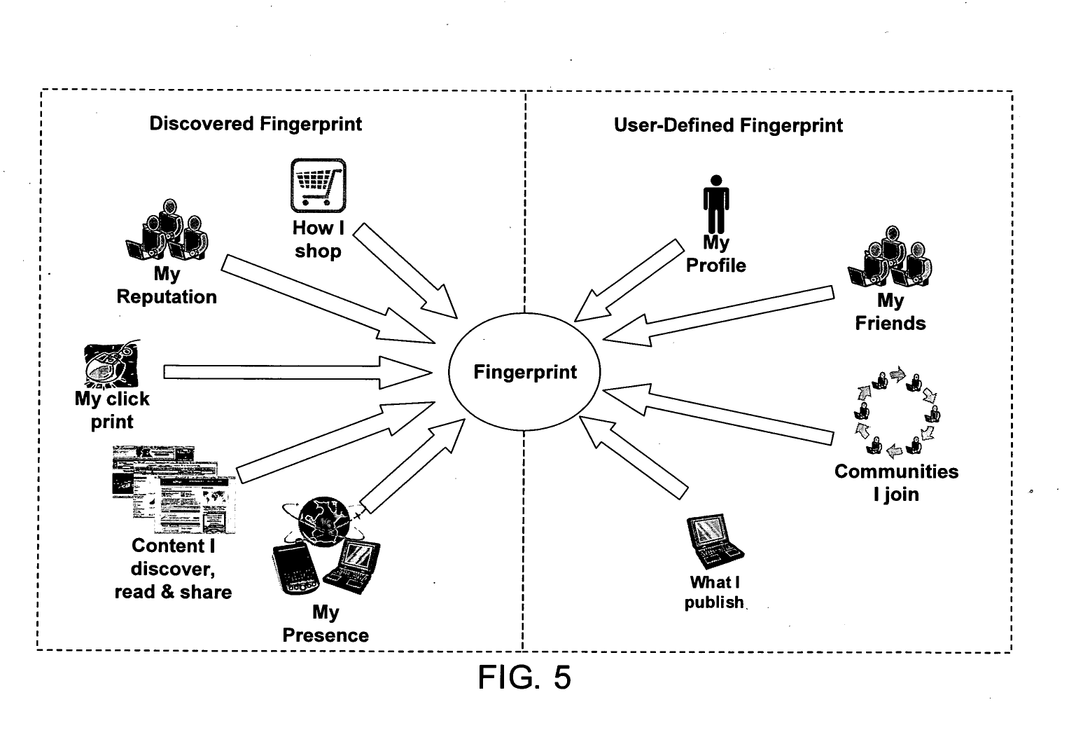

Referring next to FIG. 4, in one embodiment, subscriber fingerprints are built and maintained by processes invoked by the subscriber access component, 40, of the system, 10. When a subscriber first joins the service, an initial fingerprint, 44, is defined by a create initial fingerprint process, 72. In one embodiment, the fingerprint is initially blank. In another embodiment, see FIG. 5, the fingerprint may contain subscriber defined data, such as the subscriber's basic profile, containing, for example, demographic information, the subscriber's friends, hobbies, interests, the online communities the subscriber has joined, and materials the subscriber has published. Referring back to FIG. 4, upon creation of the fingerprint, 44, the fingerprint is then associated with applicable subscriber. If keywords or key phrases are initially placed in the fingerprint, they must be keywords or key phrases from the lexicon, 30.

Optionally, the subscriber fingerprint may be updated on a real-time basis (a “discovered fingerprint”) by an update fingerprint process, 76, invoked by the subscriber access component, 40, of the system, 10. which updates the subscriber fingerprint with data derived from the subscriber's activity on the system. For example, see FIG. 5. A subscriber's fingerprint may be modified based on the fingerprints of assets the subscriber has viewed or otherwise interacted with. Additionally or alternatively, when a subscriber accesses or shares an asset, key phrases appearing in the accessed or shared asset may be added to the subscriber's fingerprint. Additionally or alternatively, when a subscriber enters a query containing keywords or key phrases present in the query may be added to the fingerprint. Note, however, if keywords or key phrases are inserted in the subscriber's fingerprint, they must be keywords or key phrases from the lexicon, 30. Additionally or alternatively, key phrases recently added to the subscriber's fingerprint may be assigned greater weight than key phrases previously added to the subscriber's fingerprint.

Using the same lexicon to define fingerprints that describe both assets and subscribers may allow (1) assets to be compared to other assets; (2) assets to be compared to subscribers; and (3) subscribers to be compared to other subscribers. Such comparisons can be accomplished using a clustering engine that clusters related assets. In one embodiment, the clustering engine could be a component of the subscriber access component, for example, 40 of FIG. 4. Alternatively, the clustering engine could be a separate component invoked by the subscriber access component.

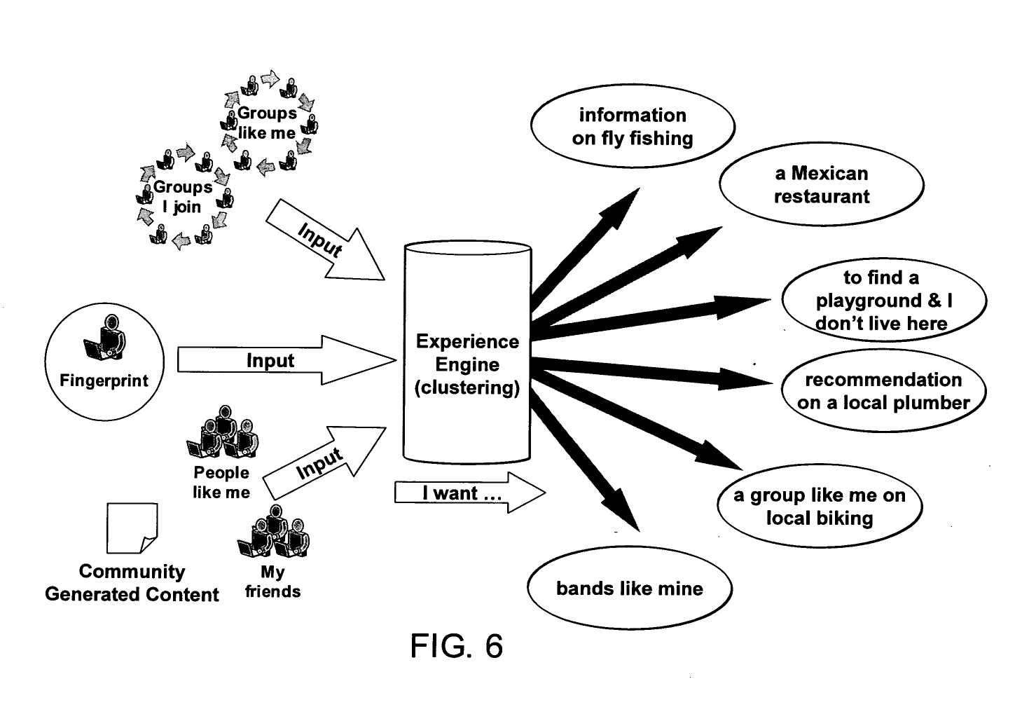

Referring next to FIG. 6, where a subscriber enters a search or a query, the clustering engine may use the fingerprints of other assets and subscribers to identify clusters of assets and subscribers which are related to the topic of interest. For example, the clustering engine could identify a cluster of reviews, articles, or subscriber recommendations for local restaurants.

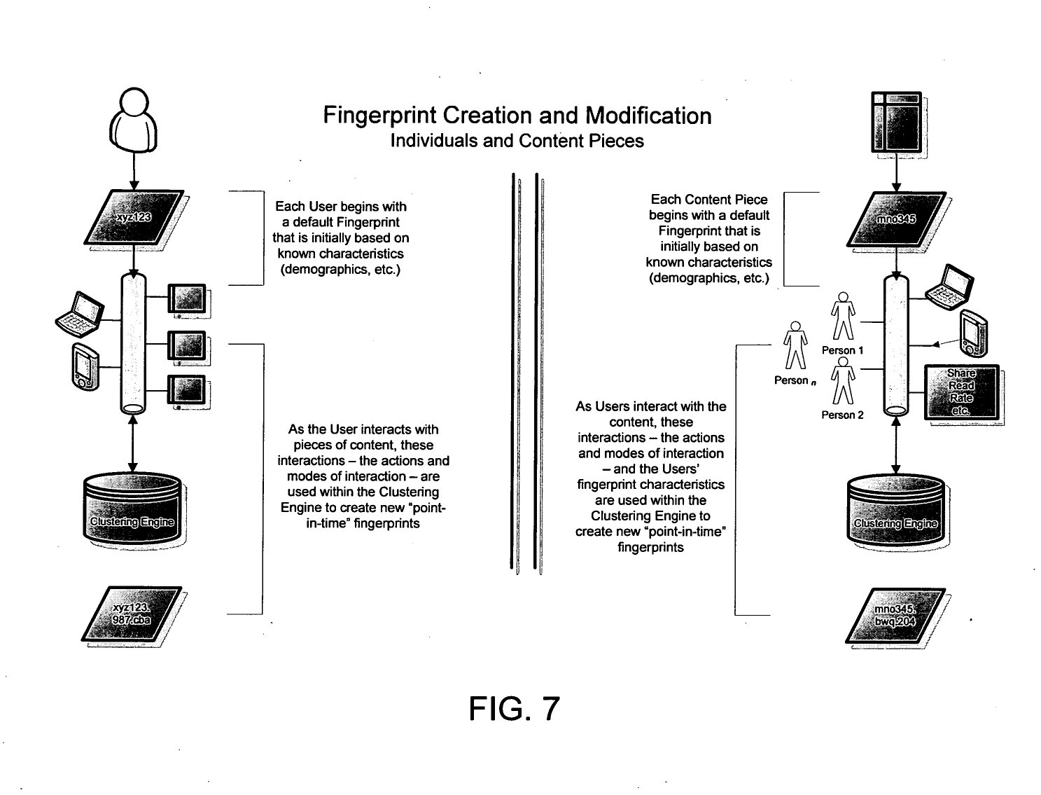

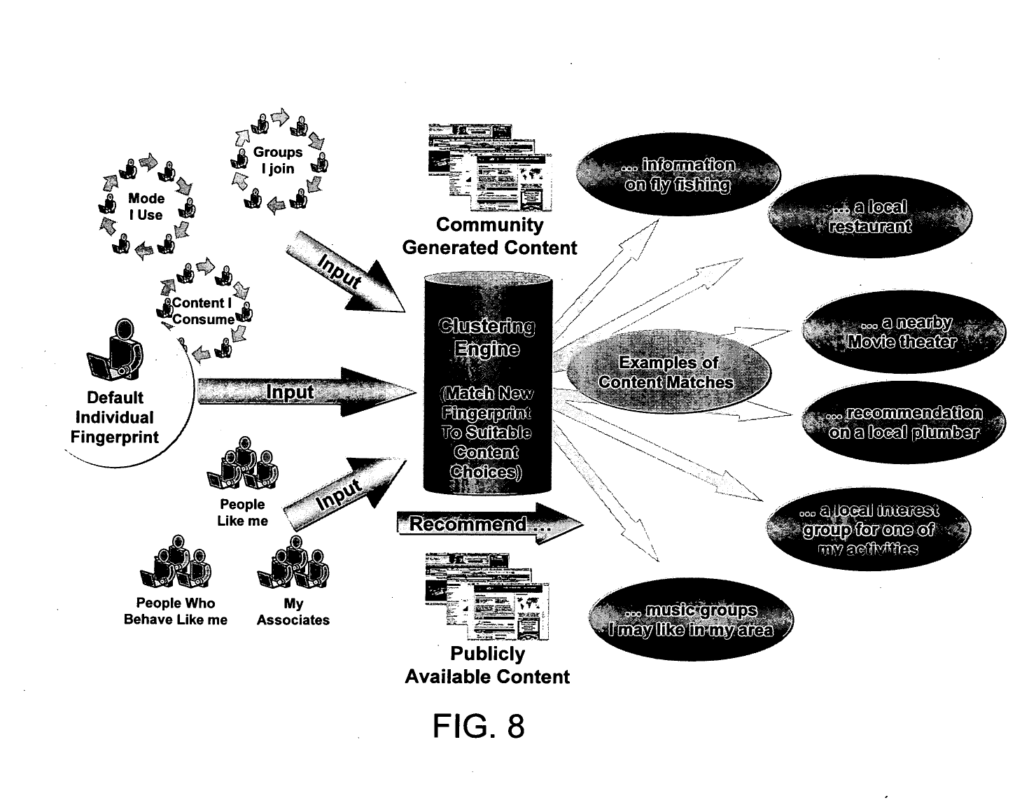

Referring next to FIG. 7, the clustering engine may dynamically update the fingerprint of assets and subscribers as subscriber consumes, shares, rates, or otherwise interacts with assets and other subscribers. Starting with an initial or default fingerprint, which may be based, for example, on based on demographics, the clustering engine uses behavioral observations (inputs) to generate a new point-in-time fingerprint for assets and subscribers. Referring next to FIG. 8, as the subscriber's point-in-time fingerprint changes, the clustering engine may dynamically recommend new assets and subscribers to the subscriber.

In order to facilitate the comparison of assets to assets, assets to subscribers, and subscribers to subscribers, relevancy scores may be determined by assigning different weights to different components of an asset's fingerprints and/or a subscriber's fingerprint. Relevancy scores may be used to determine a subscriber's interest in an asset or another subscriber. For example, if a subscriber's fingerprint shows a high asset relevancy for articles from the New York area with the phrase “Italian Restaurants,” the clustering engine may discover other assets and/or subscribers with a similar set of fingerprint characteristics and assign these assets and subscribers higher relevancy scores relative to the subscriber.

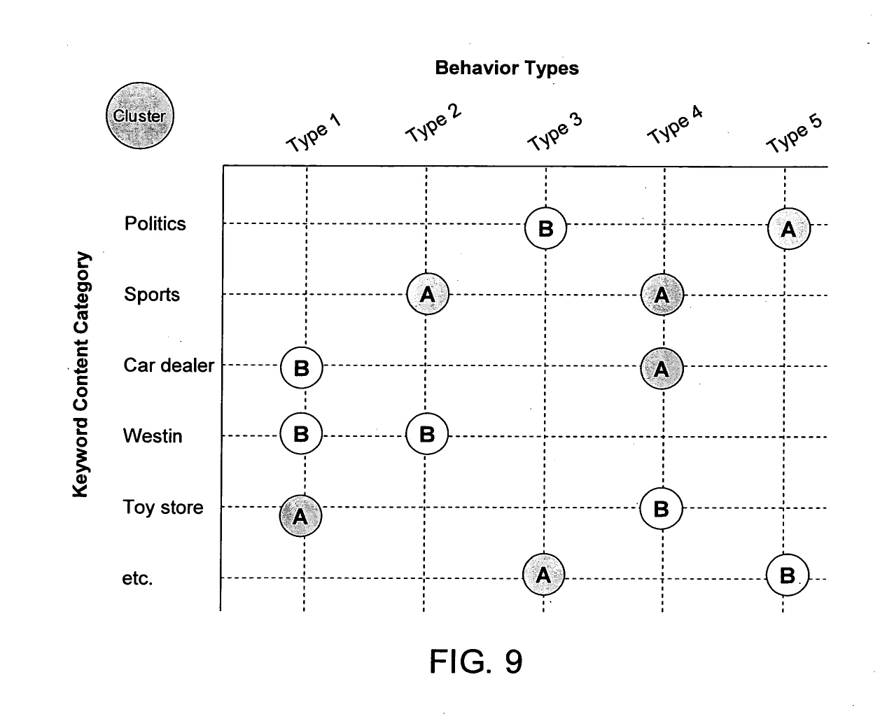

Referring next to FIG. 9, subscribers with similar fingerprints may share similar interests. Thus, clusters of subscribers that potentially share similar interests may be generated dynamically by comparing multiple subscribers' fingerprints and grouping subscribers with similar fingerprints together. The dynamic clustering of subscribers based upon similar fingerprints may facilitate targeted delivery of content, including, for example, advertising and alerts. Such content be subscriber-preferred in that the subscriber may have explicitly indicated an interest in the content or the system may have inferred an interest in the content based on the subscriber's fingerprint and/or behavior.

In one example, if a subscriber purchases a product in response to an advertisement delivered to the subscriber, the same advertisement may be sent to other subscribers having similar fingerprints. Dynamic clustering allows advertisers to identify, in real time, scalable and relevant groups as the consumers behavior and reference points change. Subscribers will freely and continually move through clusters and simultaneously exist within clusters as their preferences change, as they're exposed to new content, as we watch/learn from their behavior and as subscribers interact with other subscribers and pass along new content.

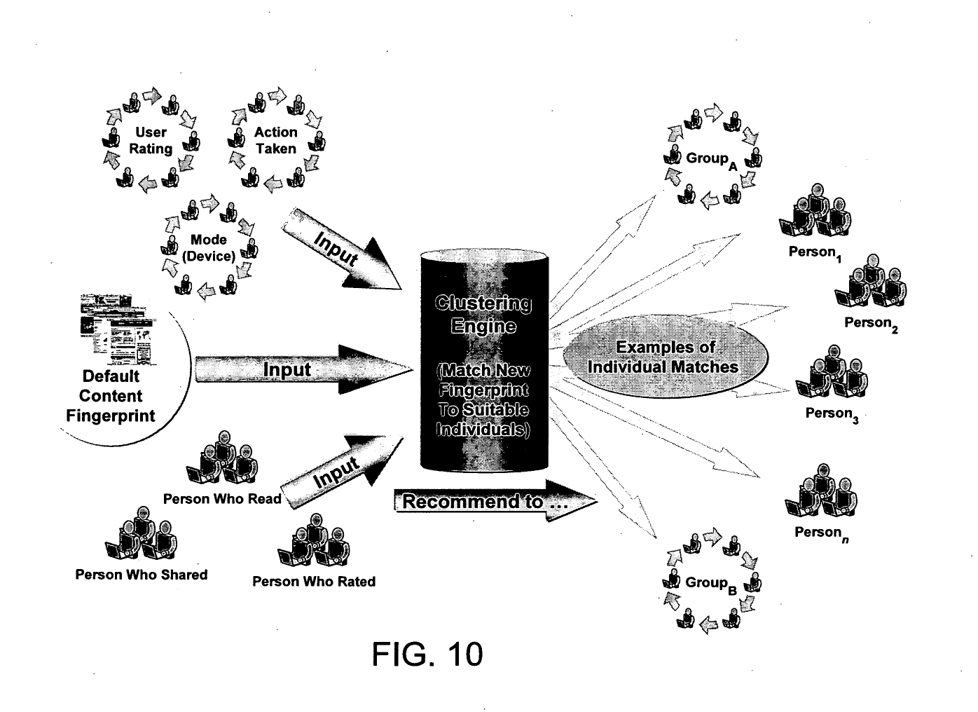

Referring next to FIG. 10, the dynamic clustering of subscribers based upon similar fingerprints also may facilitate the discovery and delivery of highly pertinent content to subscribers. For example, if a subscriber consistently accesses assets from a particular source, it may be determined that another subscriber having a similar fingerprint also may be interested in assets provided by the particular source. Consequently, assets from the particular source may be delivered to a second subscriber having a similar fingerprint. The second subscriber's response to the unsolicited delivery of such assets may be used as feedback to refine the second subscriber's fingerprint.

Additionally or alternatively, the second subscriber's response may be used as feedback for determining whether to continue delivering the asset to other subscribers having similar fingerprints. For example, if the second subscriber deletes the asset without first accessing the asset, it may be inferred that the second subscriber is not interested in the asset and the asset may not be delivered to other subscribers having similar fingerprints. In contrast, if the second subscriber accesses the asset or accesses and shares the asset with other subscribers, it may be inferred that the second subscriber is interested in the asset and the asset may be delivered to other subscribers having similar fingerprints. In another example, the second subscriber may be allowed to rate the content of the asset and the rating assigned to the asset by the second subscriber may be used as a basis for determining whether to deliver the asset to other subscribers having similar fingerprints.

Subscriber activity may be monitored to discover new sources of relevant information for subscribers with similar fingerprints. For example, if a subscriber consistently accesses content from a particular source, it may be determined that other subscribers having similar fingerprints may find assets provided by the particular source interesting and assets from the particular source may be delivered to the other subscribers having similar fingerprints.

A subscriber who receives unsolicited content based on the subscriber's association with other subscribers may be allowed to assign a rating to the received content, and the assigned rating may be used as a basis for determining whether or not to further share the content with other subscriber's associated with the subscriber.

Comparing the fingerprint of an asset to the fingerprint of the subscriber also may be used to prevent delivery to the subscriber of assets that the subscriber may find irrelevant and/or offensive. For example, a spam email filter may be implemented by comparing incoming email messages with the subscriber's fingerprint and refusing to deliver to the subscriber incoming emails that are not within a threshold level of similarity to the subscriber's fingerprint. The subscriber also may set threshold values for relevancy scores in order to filter content the subscriber may find irrelevant/uninteresting.

### Storage and Disposal of Hosted Assets

In the embodiment of the system illustrated in FIG. 1, the content available to subscribers includes locally hosted assets, 12. Such assets may be discovered and added to the system automatically, for example, by a web agent or web crawler which continuously searches for assets with specific content. Such assets may also be discovered manually or created, for example, by an administrator or by a subscriber with authority to add assets to the system. Such processes may potentially add an overwhelming number of assets to the system. Hence, it is necessary to efficiently manage the storage, disposal, distribution and delivery of such assets to avoid overloading the system.

Note that in the discussion that follows the term “distribute” is intended to refer to any process by which a subscriber is notified of an asset's existence and is provided a means to access the asset, and that the term “delivery” refers to the delivery of a physical copy of the asset to a subscriber's private storage, for example, the subscriber's computer.

In accordance with the disclosed system and method, several techniques may be used to increase the efficiency with which assets are stored locally. In one embodiment, where the system distributes an asset to a number of subscribers based upon subscribers'profiles, as for example, in the embodiment illustrated in FIG. 8., the system may store a single copy of the asset for all subscribers. The system then may then create and store a pointer pointing to the particular asset within the profile of each subscriber to which the asset has been distributed. Alternatively, a pointer to the asset could be placed in an email sent to the subscriber.

In another embodiment, the system may deliver a copy of the asset to point-of-entry devices the subscriber uses to access the system, for example, a computer, a personal digital assistant (PDA), or a mobile/cellular telephone, instead of maintaining a separate copy of the asset on the system specifically for the subscriber's use. A subscriber may register multiple point-of-entry devices with the system, and in such case, the system may deliver a copy of the asset to some or all of the subscriber's point of entry devices. Additionally or alternatively, the system may push only a portion of the new asset to the subscriber's point of entry devices. If the subscriber wishes to access the entire asset, the subscriber then may request the entire asset from the system. After an asset has been delivered to a subscriber, the subscriber may have the option of marking the asset to be saved or alternatively deleted on the system.

Timely disposal of assets is also essential to insure that the storage of local assets is efficient. In one embodiment, the host system may dispose of assets by expiring and/or deleting them. Additionally or alternatively, the host system may dispose of assets by moving them to different locations (e.g., different servers). In an embodiment of the system in which disposal of an asset involves moving the asset to a different server, the host computer may consider how frequently the asset is accessed when determining where to move the asset. For example, the host computer may move an asset that is accessed frequently to a fast server while the host computer may move an asset that is accessed infrequently to a slow server. Other methods for disposing of assets may also be possible.

Different events may trigger the disposal of an asset. For example, the system may dispose of an asset after it has been delivered at least once to each subscriber to whom it was distributed. In another example, the system may dispose of the asset after the asset has been delivered to each point of entry device for every subscriber to whom the asset was distributed. In yet another example, the system may dispose of an asset after a predefined amount of time has elapsed since the asset was distributed to a group of subscribers or after a pre-defined amount of time has elapsed since the asset was delivered to each subscriber to whom the asset was distributed, or after a pre-defined amount of time has elapsed since the asset was delivered to each point of entry device for each subscriber to whom the asset was distributed. In still another example, the system may dispose of an asset after the asset has been delivered to each subscriber to whom the asset was distributed and each subscriber to whom the asset was delivered has marked the asset for deletion.

In the case where assets are being rapidly added to the system, it is particularly important to provide for the disposal of assets that have not been accessed and/or consumed by every subscriber to which they have been distributed. On the other hand, where assets are being added relatively slowly, it may be preferable to retain assets until all subscribers to whom the asset has been distributed have accessed the asset, and, possibly, flagged it for deletion. A balance needs to be maintained between efficient use of system resources and providing broad access to assets to subscribers.

One method of tracking events that affect asset retention is to record the usage of assets by individual subscribers within each subscriber's profile. In one embodiment, the system creates and maintains a journal of all of the commands (e.g., instructions) issued by a subscriber in the course of using the system. In order to prevent a journal from growing too large, a compaction scheme may be employed whereby previous commands are compacted into a checkpoint that summarizes the state of the profile at a particular point in time. The state of the subscriber's profile may be recreated based on the checkpoint and any commands issued subsequent to the creation of the checkpoint. The system may then use the journal or the current state of the subscriber's profile to determine the usage of assets that have been distributed to the subscriber. For example, system may use a subscriber's journal or profile to determine whether an asset has been delivered to the subscriber, whether the asset has been delivered to each point of entry device for a subscriber, how many times the subscriber has accessed the asset, whether the subscriber has marked the asset for deletion, whether the subscriber has marked the asset to be saved, etc.

When an event triggers disposal of an asset, the asset may be disposed of automatically. Additionally or alternatively, an event triggering disposal may initiate an algorithm that selects and disposes of selected assets.

While the invention has been particularly shown and described with reference to a preferred embodiment thereof, it will be understood by those skilled in the art that various changes in form and details may be made therein without departing from the spirit and scope of the invention.

1. A system for efficiently storing and distributing an information asset to a plurality of subscribers, comprising:
an information asset stored on a storage medium, wherein a single copy of the asset is stored locally on the system;
a plurality of subscribers;
a processor configured to distribute a means to access the information assets to the plurality of subscribers;
said processor being further configured to identify an event that indicates an information asset should be disposed of; and
disposing of the information asset.

2. The system in claim 1, wherein said processor is further configured to execute a process that identifies subscribers with a specific interest in the information asset, and a process that only distributes a means to access the information asset to interested subscribers.

3. The system in claim 2, wherein the means to access the information asset is a pointer which identifies the physical location of the asset.

4. The system in claim 3, wherein the pointer to the asset is distributed to subscribers by storing the pointer in the subscriber's profile.

5. The system in claim 3, wherein the pointer to the asset is distributed to subscribers using email.

6. The system in claim 2, wherein the means to access the information asset is a copy of the asset which is delivered to the subscriber's point-of-entry device.

7. The system in claim 2, wherein the process that identifies subscribers with a specific interest in the information asset is a clustering engine.

8. A method for the disposal of information assets stored locally on a system comprising the steps of:
identifying an event that indicates an information asset should be disposed of; and
disposing of the information asset.

9. The method of claim 8 wherein the event that indicates an information asset should be disposed of is the occurrence of the condition that the asset has been delivered at least once to each subscriber to whom it was distributed.

10. The method of claim 8 wherein the event that indicates an information asset should be disposed of is the occurrence of the condition that the asset has been delivered at least once to each subscriber to whom it was distributed and a predefined interval of time has elapsed.

11. The method of claim 8 wherein the event that indicates an information asset should be disposed of is the occurrence of the condition that the asset has been delivered to each point of entry device for every subscriber to whom the asset was distributed.

12. The method of claim 8 wherein the event that indicates an information asset should be disposed of is the occurrence of the condition that the asset has been delivered to each point of entry device for every subscriber to whom the asset was distributed and a predefined interval of time has elapsed.

13. The method of claim 8 wherein the event that indicates an information asset should be disposed of is the occurrence of the condition that a predefined interval of time has elapsed since the asset was distributed to a plurality of subscribers.

14. The method of claim 8 wherein the event that indicates an information asset should be disposed of is the occurrence of the condition that the asset has been delivered to each point of entry device for every subscriber to whom the asset was distributed and a predetermined interval of time has elapsed.

15. The method of claim 8 wherein the event that indicates an information asset should be disposed of is the occurrence of the condition that the asset has been delivered to each subscriber to whom the asset was distributed and each subscriber to whom the asset was delivered has marked the asset for deletion.

16. The method of claim 8 wherein an information asset is disposed of by physically deleting the asset.

17. The method of claim 8 wherein an information asset is disposed of by moving the asset to another storage location within the system.

18. The method of claim 17 wherein information assets which are frequently accessed are moved to a storage location providing faster access and assets which are infrequently accessed are moved to a storage location with slower access.
